(19) United States
(12) Patent Application Publication
(10) Pub. No.: US 2016/0157155 A1
(43) Pub. Date: Jun. 2, 2016

(54) Selective Bearer Splitting in Cell System

(71) Applicant: NOKIA SOLUTIONS AND NETWORKS OY, Espoo (FI)

(72) Inventors: Tsunehiko CHIBA, Saitama (JP); Seppo llmari VESTERINEN, Oulunsalo (FI)

(21) Appl. No.: 14/904,732

(22) PCT Filed: Aug. 5, 2014
(86) PCT No.: PCT/EP2014/066800

§ 371 Date: Jan. 13, 2016

Related U.S. Application Data
(60) Provisional application No. 61/875,457, filed on Sep. 9, 2013.

(51) Int. Cl. H04W 36/24

(52) U.S. Cl. CPC H04W 36/24

(57) ABSTRACT

Selective bearer splitting may be of benefit to various communication systems. For example, selective bearer splitting may beneficial to small cell systems of the third generation partnership project (3GPP) or similar systems. A method may include determining a capacity information regarding capacity of an interface between a first base station and a second base station. The method may also include selecting, on a per user equipment's bearer service basis, a data splitting point for at least one of a plurality of bearer services for a user equipment, based on the condition of the interface.

### CROSS-REFERENCE TO RELATED APPLICATIONS

This application is related to and claims the benefit and priority of U.S. Provisional Patent Application No. 61/875,457, filed Sep. 9, 2013, which is hereby incorporated by reference in its entirety.

### BACKGROUND

1. Field

Selective bearer splitting may be of benefit to various communication systems. For example, selective bearer splitting may beneficial to small cell systems of the third generation partnership project (3GPP) or similar systems.

2. Description of the Related Art

Small Cell is a topic of third generation partnership (3GPP) radio access network (RAN) for release 12 (Rel-12), for example in 3GPP technical report (TR) 36.842, “Study on Small Cell Enhancements for E-UTRA and E-UTRAN—Higher layer aspects,” which is hereby incorporated herein by reference in its entirety.

While there are multiple possible architectures, two architecture alternatives may be example architectures with dual connectivity in RAN2 and RAN3. In alternative 1, as shown in FIG. 1, small cell evolved Node B (SeNB) has S1-U connection to code network (CN) per user equipment (UE) without S1-MME connection in case of dual connectivity with dual radio connection. Instead there is an X2 interface between macro eNB (MeNB) and SeNB. This X2 interface is for control plane signaling transmission (X2-C). For dual radio dual connection, the UE control plane (C-plane) is connected to a mobility management entity (MME) only via MeNB whereas user plane (U-plane) may have connections to both MeNB and SeNB. A serving gateway (S-GW) sees two GTP-U tunnel endpoints per UE in both MeNB and SeNB. X2-C is needed for MeNB to control the SeNB for offloading purpose. In this alternative for dual connectivity support, bearer splitting at MeNB is not supported and SeNB may route the user data directly to CN without aggregation by MeNB.

In alternative 2 as shown in FIG. 2, the SeNB is connected to the MeNB via X2 interface and has neither direct S1-MME nor S1-U interface towards the CN in case of dual connectivity with dual radio connection. In this alternative, dual radio connectivity can be supported by using X2 interface transparently to CN nodes such as a serving gateway (S-GW). EUTRAN radio access bearer (E-RAB) offloading can be supported by SeNB but still concentrated at MeNB via X2 interface. There is only one S1-MME signaling connection with MME per UE. The backhaul capacity between the MeNB and the first intermediate router towards the S-GW needs to account for the traffic between the MeNB and the SeNB. Another aspect for this alternative, in terms of dual radio connection, is that bearer splitting at MeNB, which increases the per-user throughput by flexible management of bearer, is possible.

There is a tradeoff between two alternatives. If backhaul between MeNB and SeNB is high capacity, alternative 2 may be better from user throughput perspective, although complexity is high in MeNB and UE for bearer splitting. On the other hand, if backhaul between MeNB and SeNB is low capacity and some delay expected, alternative 1 may be better because user plane is not affected and complexity is low. Further details are shown in R2-132413, 3GPP RAN2 contributions, which is hereby incorporated hereby reference in its entirety.

However, there is no mechanism to flexibly support both alternatives considering the backhaul situation, which may be different even within a single operator.

### SUMMARY

According to certain embodiments, a method can include determining a capacity information regarding capacity of an interface between a first base station and a second base station. The method can also include selecting, on a per user equipment's bearer service basis, a data splitting point for at least one of a plurality of bearer services for a user equipment, based on the condition of the interface.

In certain embodiments, a non-transitory computer-readable medium can be encoded with instructions that, when executed in hardware, perform the above-described method. Similarly, a computer program product can, in certain embodiments, encode instructions to perform the above-described method.

An apparatus, according to certain embodiments, can include at least one processor and at least one memory including computer program code. The at least one memory and the computer program code can be configured to, with the at least one processor, cause the apparatus at least to determine a capacity information regarding capacity of an interface between a first base station and a second base station. The at least one memory and the computer program code can also be configured to, with the at least one processor, cause the apparatus at least to select, on a per user equipment's bearer service basis, a data splitting point for at least one of a plurality of bearer services for a user equipment, based on the condition of the interface.

An apparatus, in certain embodiments, can include means for determining a capacity information regarding capacity of an interface between a first base station and a second base station. The apparatus can also include means for selecting, on a per user equipment's bearer service basis, a data splitting point for at least one of a plurality of bearer services for a user equipment, based on the condition of the interface.

### BRIEF DESCRIPTION OF THE DRAWINGS

For proper understanding of the invention, reference should be made to the accompanying drawings, wherein:

FIG. 1 illustrates a first alternative for an architecture for dual connectivity.

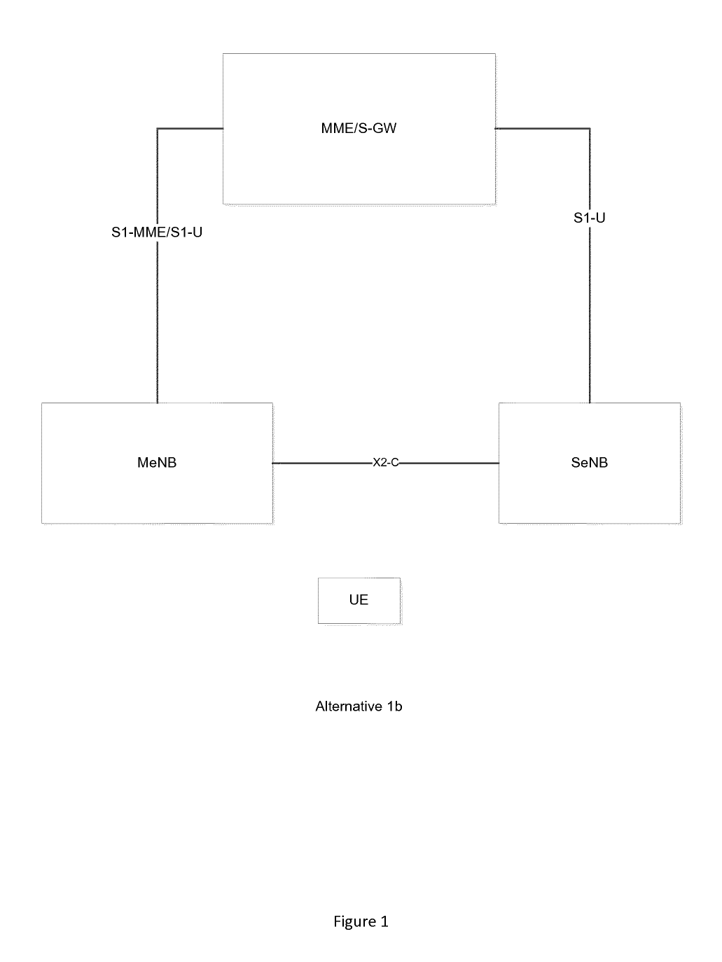

FIG. 2 illustrates a second alternative for an architecture for dual connectivity.

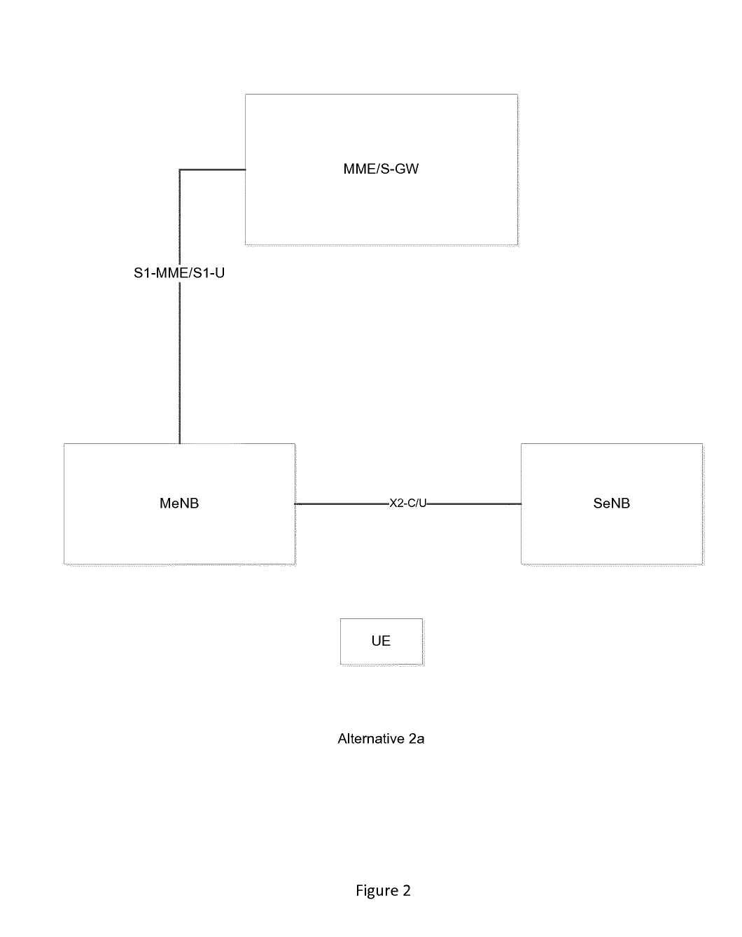

FIG. 3 illustrates an architecture for selective data splitting in a small cell, according to certain embodiments.

FIG. 4 illustrates one implementation of selecting a data splitting point at S-GW, according to certain embodiments.

FIG. 5 illustrates one implementation of selecting a data splitting point at MeNB, according to certain embodiments.

FIG. 6 illustrates a system according to certain embodiments.

FIG. 7 illustrates a method according to certain embodiments.

### DETAILED DESCRIPTION

Certain embodiments provide dynamic selection of data splitting per user's bearer service. For example, certain embodiments permit simultaneous operation of a data splitting point in the S-GW for some offloaded bearer service and a data splitting point in the MeNB for other bearer services in a small cell deployment.

Certain embodiments relate to long term evolution advanced (LTE-A) and in particular to small cell environments and data offloading/splitting. In conventional understandings of such, there is no mechanism to flexibly support splitting/data offloading, especially when looking at the backhaul connection. Certain embodiments use capacity information on the X2 interface to dynamically select a point for data splitting. Depending on the capacity, the split can be done at the serving gateway when the capacity information indicates a high capacity or the split can be done at a Master-eNB when the capacity information indicates a low capacity.

Thus, certain embodiments may be applicable to a small cell system for long term evolution (LTE) and beyond systems. In more detail, certain embodiments may provide a method to flexibly support data offloading and splitting for LTE small cell.

More particularly certain embodiments provide a method to flexibly support user data offloading based on the X2 capacity in small cell system using dynamic selection of data splitting point. For example, if X2 load or packet delay is high, then the MeNB can select architecture alternative 1, namely data splitting point is S-GW. If X2 load or packet delay is low, then the MeNB can select architecture alternative 2 i.e. data splitting point is MeNB.

The MeNB can obtain X2 capacity information from existing messages or new messages, or by other methods such as operations, administration, and maintenance (OAM).

For dual connectivity capable UEs, certain embodiments provide a dynamic selection of data splitting per user's bearer service. For example, there can be simultaneous operation of having a data splitting point in the S-GW for some offloaded bearer service and a data splitting point in the MeNB for other bearer services.

Thus certain embodiments can provide dynamic selection of data splitting point per a evolved universal terrestrial radio access network (E-UTRAN) Radio Access Bearer (E-RAB) to offload some or all UE bearer services to a SeNB from the MeNB in order to release macro cell radio resources to other UEs.

Moreover, in certain embodiments dynamic selection of the offloaded bearer routing can either be by aggregating via the MeNB, or by using direct tunneling from the SeNB to the S-GW depending on the MeNB loading, X2 capacity and transport network topology, and the like.

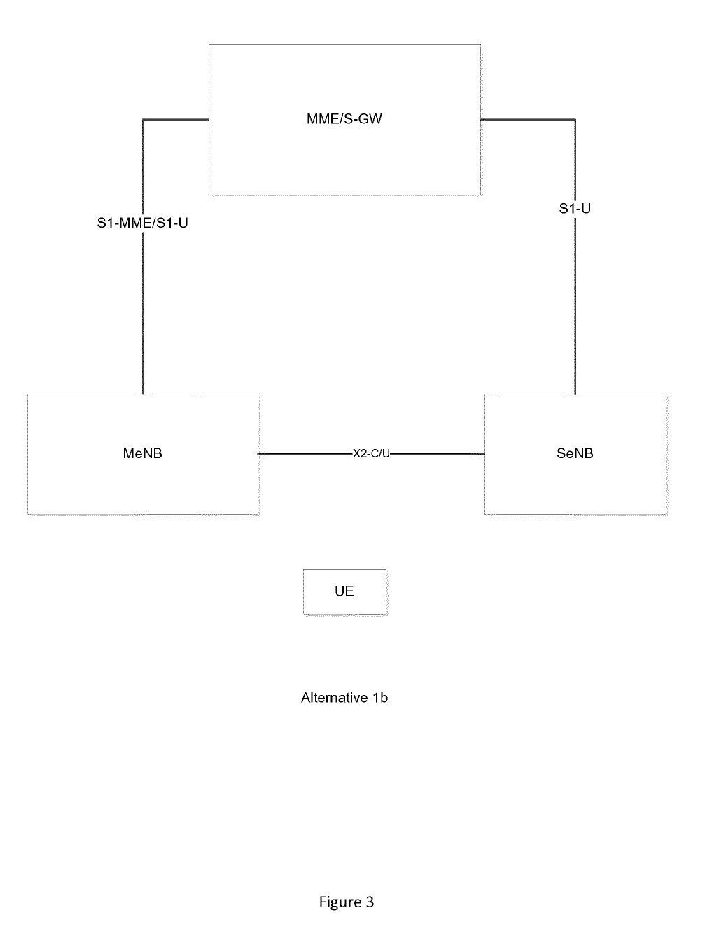

FIG. 3 illustrates an architecture for selective data splitting in a small cell, according to certain embodiments. In this architecture SeNB can have a direct S1-U connection to CN and to X2-U. Thus, in this architecture SeNB can support both X2-U and S1-U. If X2-U is based on a general packet radio service (GPRS) tunneling protocol (GTP) user plane (GTP-U), for example the same protocol as S1-U, the only difference between the two interfaces may be the tunnel endpoint identifier (TEID) and internet protocol (IP) address. A generic routing encapsulation (GRE) key can be similar to the TEID in case the Generic Routing Encapsulation protocol is used for user plane tunneling over the IP transport network. The X2-U interface could apply the GRE protocol instead of GTP.

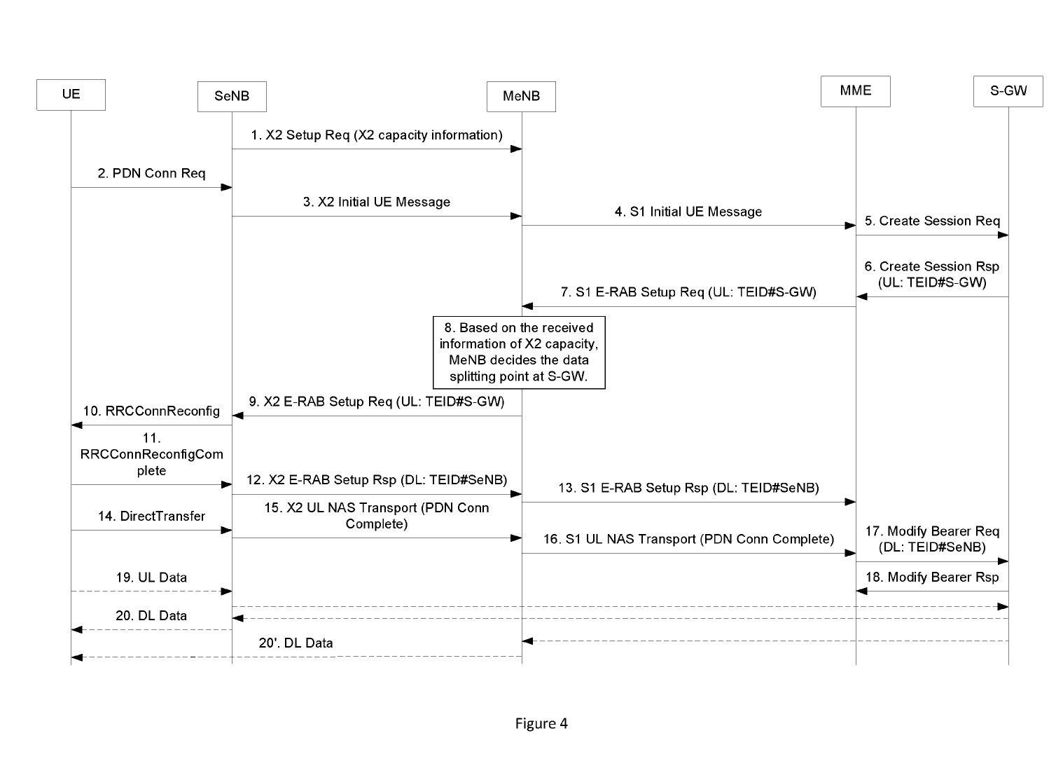

FIG. 4 illustrates one implementation of selecting a data splitting point at S-GW, according to certain embodiments. As shown in FIG. 4, at 1, during the X2 setup procedure, the SeNB can inform the MeNB of X2 capacity information including delay, which the SeNB can check by pinging or other methods. The MeNB may obtain the delay information from a SeNB timestamp of any message.

At 2, the UE can send a packet data network (PDN) connection request to the SeNB. In this example, it is assumed that radio resource control (RRC) terminates at SeNB. If RRC terminates at MeNB using SeNB as a relay node, this message can instead be terminated in MeNB.

At 3, the SeNB can send an X2 Initial UE Message to MeNB. Then, at 4, the MeNB can send an S1 Initial UE Message. Next, at 5 the MME can send a Create Session Request to S-GW. At 6, the S-GW can send a Create Session Response to MME. The MME can send, at 7, an S1 E-RAB Setup Request to MeNB.

At 8, the MeNB can check the current X2 capacity information and decides tha data splitting point at S-GW. At 9, the MeNB can send an X2 E-RAB Setup Request including TEID#S-GW for uplink to SeNB.

At 10-11, the SeNB can initiate an RRC Reconfiguration procedure. Then, at 12-13 the SeNB can send an X2 E-RAB Setup Response including TEID#SeNB for down link to MeNB, which can be forwarded to the MME.

At 14-16, the UE can send a Direct Transfer command including NAS PDN Connectivity Complete message to SeNB, which can be forwarded to MME. At 17-18, the MME can initiate a Bearer Modify procedure with indication of TEID#SeNB for downlink to S-GW.

At 19, the uplink (UL) data can be sent directly from SeNB to S-GW. Then, at 20 the downlink (DL) data can be sent directly from S-GW to SeNB. Data may be split at S-GW.

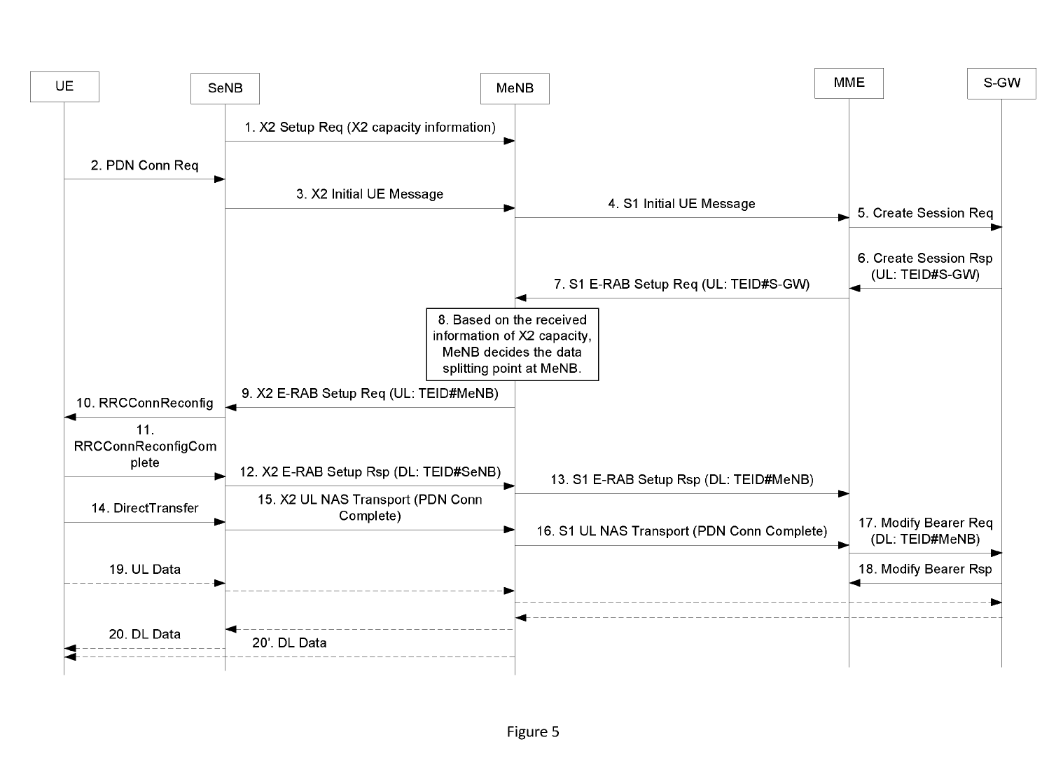

FIG. 5 illustrates one implementation of selecting a data splitting point at MeNB, according to certain embodiments. At 1-7, the procedure can be the same procedure as FIG. 4.

At 8, the MeNB can check the current X2 capacity information and can decide that the data splitting point is to be at the MeNB. At 9, the MeNB can send an X2 E-RAB Setup Request including TEID#MeNB for uplink to SeNB. Then, at 10-11, the SeNB can initiate an RRC Reconfiguration procedure.

At 12, the SeNB can send an X2 E-RAB Setup Response including TEID#SeNB for downlink to MeNB. At 13, the MeNB can send an S1-ERAB Setup Response including TEID#MeNB for downlink to MME after changing the TEID received from SeNB.

At 14-16, the UE can send Direct Transfer including NAS PDN Connectivity Complete message to SeNB, which is forwarded to the MME. Then, at 17-18, the MME can initiate a Bearer Modify procedure with indication of TEID#MeNB for downlink to S-GW.

At 19, the UL data can be sent from SeNB to S-GW via MeNB. Then, at 20, the DL data can be sent from S-GW to SeNB via MeNB. The data may be split at the MeNB.

There may be various bearer management functions for selecting data split mode in the MeNB. For example, when a UE is connected just to the MeNB then its Radio Bearer (RB) configurations are handled based on their corresponding E-RAB parameters and traffic is routed from the MeNB to the S-GW as usual.

When a UE with single radio connection is connected just to the SeNB, then its Data Radio Bearer (DRB) configurations can be handled in control of the anchor MeNB based on their corresponding E-RAB parameters.

In certain embodiments, the MeNB can configure U-plane routing from/to SeNB for each bearer service either to use GTP-tunnel over X2 interface (aggregated and relayed via MeNB to the S-GW), or over direct S1-U interface to the S-GW Moreover, the serving MeNB may report any S1-U tunnel endpoint in DL to the MME per E-RAB. The tunnel endpoint parameters in S1-U can be TNL Address, namely the eNB's IP Address, and TEID, a unique identifier in GTP protocol header for a bearer.

The MeNB may need to get the SeNB's IP address and its allocated TEID value from the SeNB while configuring the data bearer via a SeNB. This may be the case for both routing options.

The criteria for the preferred U-plane routing selection could be based on the transport network deployment, if a direct data path is available, and/or MeNB loading situation.

When a dual connectivity capable UE has a PCell radio connection via the MeNB and there has been established a secondary radio connection via a SeNB/SCell then the anchor MeNB can begin to determine how to use radio resources in the SeNB and can re-configure radio bearers (RBs) for their corresponding E-RABs either to be offloaded via the SeNB, or to establish a split bearer service(s) using dual connectivity, for example a Carrier Aggregated (CA) bearer service.

Criteria for offloading at least one E-RAB, more, or even all E-RABs to use SeNB radio resources can include, for example, the loading situation in the PCell, for example due to high number of concurrent users. The additional SeNB radio resources can help in maintaining the service level for all the served UEs, because not all the UEs may be capable of dual connectivity.

The selection of the offloaded E-RAB services could be based on the quality of service (QoS) properties of each E-RAB which are given from the MME in order to let the MeNB configure the corresponding RBs accordingly. The MeNB does not need to be aware of EPS bearer level issues. Thus, the MeNB may not determine which E-RAB is the default bearer when the UE has multiple E-RABs at the same time.

For the offloaded E-RAB(s), the selection criteria for the preferred U-plane routing could be based on the transport network deployment, if a direct data path is available, and/or MeNB loading situation

Criteria for establishing a Carrier Aggregated E-RAB service can include, for example, the UE capability, low X2 delay and available radio resources both in the MeNB and the SeNB.

Certain embodiments may have various benefits and/or advantages. For example, in certain embodiments the operator does not need to select one architecture alternative or manually configure the mode of operation, where there is a tradeoff depending on backhaul situation dynamically changing.

Moreover, in certain embodiments user throughput becomes higher. This may be due to the fact that certain embodiments provide a flexible Small Cell architecture supporting dual connectivity capable UEs and legacy UEs by using available radio and backhaul resources optimally.

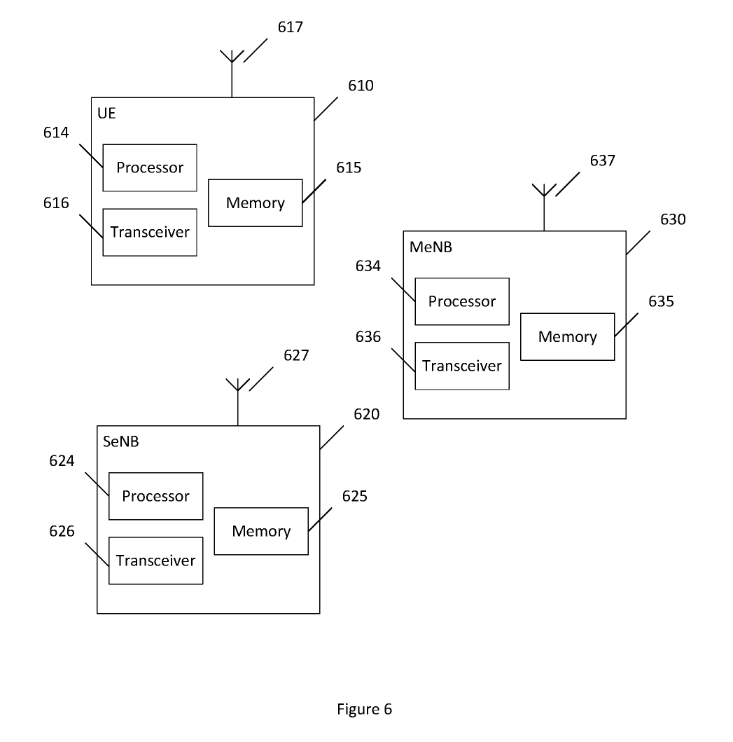

FIG. 6 illustrates a system according to certain embodiments of the invention. In one embodiment, a system may include multiple devices, such as, for example, at least one UE 610, at least one SeNB 620 or other base station or access point, and at least one MeNB 630 or other base station or access point.

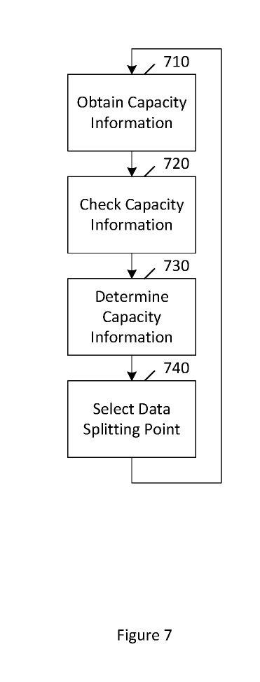

Each of these devices may include at least one processor, respectively indicated as 614, 624, and 634. At least one memory can be provided in each device, and indicated as 615, 625, and 635, respectively. The memory may include computer program instructions or computer code contained therein. The processors 614, 624, and 634 and memories 615, 625, and 635, or a subset thereof, can be configured to provide means corresponding to the various blocks of FIG. 7.

As shown in FIG. 6, transceivers 616, 626, and 636 can be provided, and each device may also include an antenna, respectively illustrated as 617, 627, and 637. Other configurations of these devices, for example, may be provided. For example, MeNB 630 may be configured for wired communication, in addition to wireless communication, and in such a case antenna 637 can illustrate any form of communication hardware, without requiring a conventional antenna.

Transceivers 616, 626, and 636 can each, independently, be a transmitter, a receiver, or both a transmitter and a receiver, or a unit or device that is configured both for transmission and reception.

Processors 614, 624, and 634 can be embodied by any computational or data processing device, such as a central processing unit (CPU), application specific integrated circuit (ASIC), or comparable device. The processors can be implemented as a single controller, or a plurality of controllers or processors.

Memories 615, 625, and 635 can independently be any suitable storage device, such as a non-transitory computer-readable medium. A hard disk drive (HDD), random access memory (RAM), flash memory, or other suitable memory can be used. The memories can be combined on a single integrated circuit as the processor, or may be separate from the one or more processors. Furthermore, the computer program instructions stored in the memory and which may be processed by the processors can be any suitable form of computer program code, for example, a compiled or interpreted computer program written in any suitable programming language.

The memory and the computer program instructions can be configured, with the processor for the particular device, to cause a hardware apparatus such as UE 610, SeNB 620, and MeNB 630, to perform any of the processes described herein (see, for example, FIGS. 4, 5, and 7). Therefore, in certain embodiments, a non-transitory computer-readable medium can be encoded with computer instructions that, when executed in hardware, perform a process such as one of the processes described herein. Alternatively, certain embodiments of the invention can be performed entirely in hardware.

Furthermore, although FIG. 6 illustrates a system including a UE, SeNB, and MeNB, embodiments of the invention may be applicable to other configurations, and configurations involving additional elements. For example, not shown, additional UEs may be present, and additional core network elements may be present, as illustrated in FIGS. 4 and 5.

FIG. 7 illustrates a method according to certain embodiments. As shown in FIG. 7, a method can include, at 710, obtaining information regarding an interface between a first base station and a second base station. The method can also include, at 720, checking the information regarding the interface. The information can be capacity information.

The method can also include, at 730, determining the capacity information regarding capacity of the interface between the first base station and the second base station. This determining can be based on the obtained information and/or the checking mentioned above. For example, the determining can be based on a MeNB obtaining X2 capacity information from existing messages or new messages, or by other methods such as operations, administration, and maintenance (OAM).

The method can also include, at 740, selecting, on a per user equipment's bearer service basis, a data splitting point for at least one of a plurality of bearer services for a user equipment, based on the condition of the interface.

Specifically, the selecting can include selecting either a macro evolved node B or a serving gateway. Thus, the first base station can be a macro evolved node B and the second base station can be a small cell evolved node B. The method can be performed by the first base station.

When load of the interface or packet delay of the interface is high, the data splitting point selected can be a serving gateway. By contrast, when load of the interface or packet delay of the interface is high, the data splitting point selected is a macro evolved node B. Thus, the selecting can include selecting aggregating via a macro evolved node B or selecting direct tunneling from a small cell evolved node B to a serving gateway.

The selecting can include selecting for simultaneous operation a first data splitting point in a serving gateway for some offloaded bearer service and a second data splitting point in a macro evolved node B for other bearer services.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

### GLOSSARY

3GPP Third Generation Partnership Project

ASIC Application Specific Integrated Circuit

CA Carrier Aggregation

CN Core Network

CPU Central Processing Unit

DL Downlink

eNB evolved Base Station, evolved Node B

E-RAB EUTRAN Radio Access Bearer

EUTRAN Enhanced UTRAN

GPRS General Packet Radio Service

GRE Generic Routing Encapsulation

GTP GPRS Tunneling Protocol

GTP-U GTP User plane

HDD Hard Disk Drive

IP Internet Protocol

LTE Long Term Evolution

LTE-A LTE Advanced

MeNB Master eNB, Macro eNB

MME Mobility Management Entity

OAM Operations, Administration, and Maintenance

PCell Primary Cell

QoS Quality of Service

RAM Random Access Memory

RAN Radio Access Network

RRC Radio Resource Control

SCell Secondary Cell

SeNB Secondary eNB, Small cell eNB

S-GW Serving GateWay

TEID Tunnel Endpoint Identifier

TR Technical Report

UE User Equipment

UL Uplink

UTRAN Universal Terrestrial Radio Access Network

1. A method, comprising:
determining a capacity information regarding capacity of an interface between a first base station and a second base station; and
selecting, on a per user equipment's bearer service basis, a data splitting point for at least one of a plurality of bearer services for a user equipment, based on the condition of the interface.

2. The method of claim 1, wherein the selecting comprises selecting either a macro evolved node B or a serving gateway.

3. The method of claim 1, wherein the first base station comprises a macro evolved node B and the second base station comprises a small cell evolved node B.

4. The method of claim 1, wherein when load of the interface or packet delay of the interface is high, the data splitting point selected is a serving gateway.

5. The method of claim 1, wherein when load of the interface or packet delay of the interface is low, the data splitting point selected is a macro evolved node B.

6. The method of claim 1, wherein the selecting comprises selecting for simultaneous operation a first data splitting point in a serving gateway for some offloaded bearer service and a second data splitting point in a macro evolved node B for other bearer services.

7. The method of claim 1, wherein the selecting comprises selecting aggregating via a macro evolved node B or selecting direct tunneling from a small cell evolved node B to a serving gateway.

8. An apparatus, comprising:
at least one processor; and
at least one memory including computer program code.
wherein the at least one memory and the computer program code are configured to, with the at least one processor, cause the apparatus at least to
determine a capacity information regarding capacity of an interface between a first base station and a second base station; and
select, on a per user equipment's bearer service basis, a data splitting point for at least one of a plurality of bearer services for a user equipment, based on the condition of the interface.

9. The apparatus of claim 8, wherein the at least one memory and the computer program code are configured to, with the at least one processor, cause the apparatus at least to select by selecting either a macro evolved node B or a serving gateway.

10. The apparatus of claim 8, wherein the first base station comprises a macro evolved node B and the second base station comprises a small cell evolved node B.

11. The apparatus of claim 8, wherein when load of the interface or packet delay of the interface is high, the at least one memory and the computer program code are configured to, with the at least one processor, cause the apparatus at least to select the data splitting point to be a serving gateway.

12. The apparatus of claim 8, wherein when load of the interface or packet delay of the interface is low, the at least one memory and the computer program code are configured to, with the at least one processor, cause the apparatus at least to select the data splitting point to be a macro evolved node B.

13. The apparatus of claim 8, wherein the at least one memory and the computer program code are configured to, with the at least one processor, cause the apparatus at least to select by selecting for simultaneous operation a first data splitting point in a serving gateway for some offloaded bearer service and a second data splitting point in a macro evolved node B for other bearer services.

14. The apparatus of claim 8, wherein the at least one memory and the computer program code are configured to, with the at least one processor, cause the apparatus at least to select by selecting aggregating via a macro evolved node B or selecting direct tunneling from a small cell evolved node B to a serving gateway.

15. An apparatus, comprising:
means for determining a capacity information regarding capacity of an interface between a first base station and a second base station; and
means for selecting, on a per user equipment's bearer service basis, a data splitting point for at least one of a plurality of bearer services for a user equipment, based on the condition of the interface.

16. The apparatus of claim 15, wherein the selecting comprises selecting either a macro evolved node B or a serving gateway.

17. The apparatus of claim 15, wherein the first base station comprises a macro evolved node B and the second base station comprises a small cell evolved node B.

18. The apparatus of claim 1, wherein when load of the interface or packet delay of the interface is high, the data splitting point selected is a serving gateway.

19. The apparatus of claim 15, wherein when load of the interface or packet delay of the interface is low, the data splitting point selected is a macro evolved node B.

20. The apparatus of claim 15, wherein the selecting comprises selecting for simultaneous operation a first data splitting point in a serving gateway for some offloaded bearer service and a second data splitting point in a macro evolved node B for other bearer services.

21. The apparatus of claim 15, wherein the selecting comprises selecting aggregating via a macro evolved node B or selecting direct tunneling from a small cell evolved node B to a serving gateway.

22. A non-transitory computer-readable medium encoded with instructions that, when executed in hardware, perform a process, the process comprising the method of claim 1.

23. A computer program product encoding instructions to perform a process, the process comprising the method of claim 1.
